(19) United States
(12) Patent Application Publication
(10) Pub. No.: US 2010/0196110 A1
(43) Pub. Date: Aug. 5, 2010

(54) REAMER

(75) Inventor: Dieter Kress, Aalen (DE)

Correspondence Address: HARNESS, DICKEY & PIERCE, P.L.C., P.O. BOX 828, BLOOMFIELD HILLS, MI, 48303, US

(73) Assignee: MAPAL FABRIK FUR PRAZISIONWERKZEUGE DR. KRESS KG, Aalen (DE)

(21) Appl. No.: 12/676,114

(22) PCT Filed: Sep. 2, 2008
(86) PCT No.: PCT/EP08/07145

§ 371 Date: Mar. 2, 2010

(30) Foreign Application Priority Data
Sep. 4, 2007 (DE) 10 2007 041 933.5
Oct. 2, 2007 (DE) 10 2007 048 633.4

(51) Int. Cl. B23D 77/02

(52) U.S. Cl. 408/147

(57) ABSTRACT

A reamer is proposed, having a basic body (3), at least one cutting tip (13) disposed essentially parallel to a face (11) of the reamer (1), which has a geometrically defined major cutting edge and a geometrically defined minor cutting edge (29, 27), and is held on a support surface (19) of the base body (3) by a tightening screw (39) that penetrates the cutting tip (13), where a back (17) of the cutting tip (13), which is polygonal in a bottom view, lies against the support surface (19), and having an adjustment device having an adjustment screw that acts on the cutting tip (13), which screw introduces adjustment forces into a side surface of the cutting tip (13). The reamer is characterized in that the ratio of the diameter (55) of an imaginary in-circle (53) that is tangential to the side edges (41, 41′, 45, 45′) of the back (17) of the cutting tip (13), relative to the thickness (d) of the cutting tip (13), lies in a range of 1.0 to 1.5, preferably in a range of 1.2 to 1.5.

The invention relates to a reamer in accordance with the preamble of claim 1.

Reamers of the type being discussed here are known. They have a base body, at least one cutting tip disposed essentially parallel to a face surface of the reamer, as well as an adjustment device. The at least one cutting tip has a major cutting edge and a minor cutting edge that follows it. In general, the major cutting edge is inclined in the advancing direction of the tool, and the minor cutting edge is inclined in the opposite direction. The deciding factor for good surface quality values of the worked bore is that in the region of the minor cutting edge, a drop of 1μ to 3μ, preferably of 1μ to 1 mm, occurs, which is referred to as a narrowing, and that this is maintained even when the diameter of the reamer is adjusted. It has turned out that the narrowing of the minor cutting edge frequently has to be changed and readjusted when setting the diameter of the reamer, because otherwise, it is not possible to guarantee high surface quality values of the worked bore.

It is therefore the task of the invention to create a reamer that avoids the disadvantages mentioned.

To accomplish this task, a reamer of the type indicated initially is proposed, which shows the characteristics indicated in claim 1. It has a base body, at least one cutting tip, as well as an adjustment device. The cutting tip is provided with at least one geometrically defined major cutting edge and one geometrically defined minor cutting edge. With its back, it lies against a support surface that is provided on the base body of the reamer. The cutting tip is configured to be polygonal in a bottom view. It is pressed against the support surface by a tightening screw that penetrates the cutting tip. The position of the cutting tip, which is inserted into a face of the reamer, can be adjusted by means of an adjustment device. In this connection, the radial projection of the major and minor cutting edges is set to a desired dimension, in order to guarantee a defined working diameter. In this connection, the cutting tip slides on the support surface. In order for the cutting tip to lie on the support surface well and securely, the size of the back is selected to be as large as possible. The reamer is characterized in that the ratio of the diameter of an imaginary in-circle, which is tangential to the side edges of the cutting tip, relative to the thickness of the cutting tip, lies in a range of 1.0 to 1.5. A ratio of the diameter of the in-circle to the tip thickness of at least 1.2 has particularly proven itself, where 1.5 is selected as an upper limit value.

Other embodiments are evident from the dependent claims.

The invention will be explained in greater detail in the following, using the drawing. This shows:

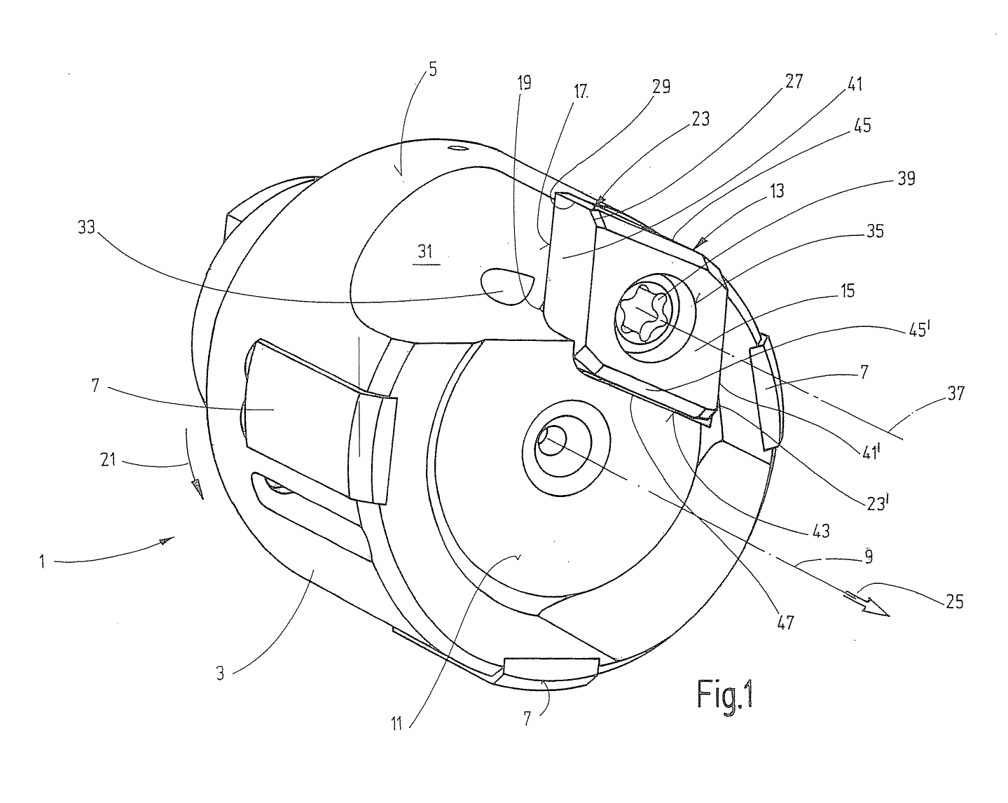

FIG. 1 a perspective front view of the reamer;

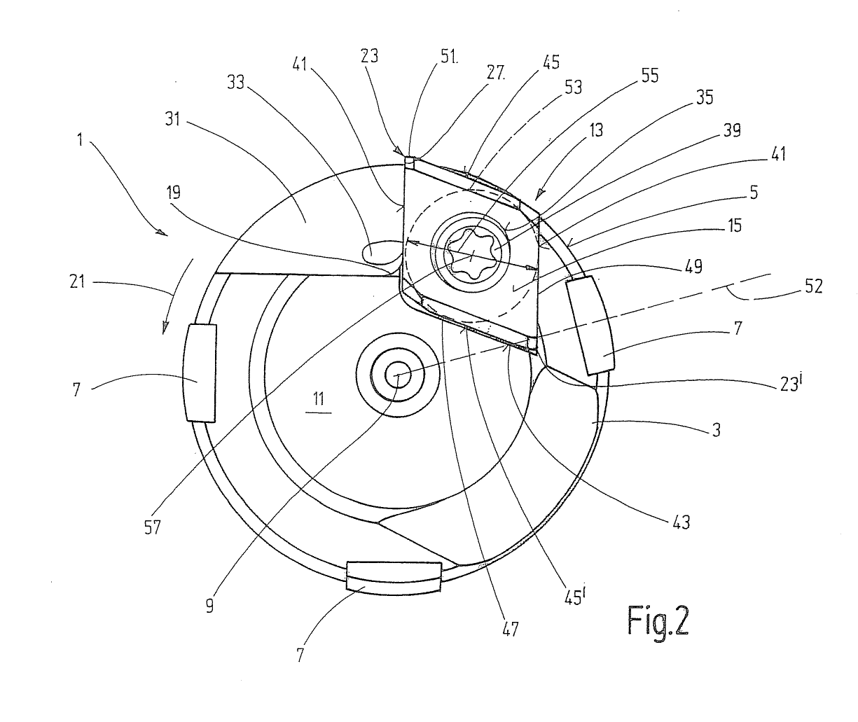

FIG. 2 a top view of the front of the reamer according to FIG. 1, and

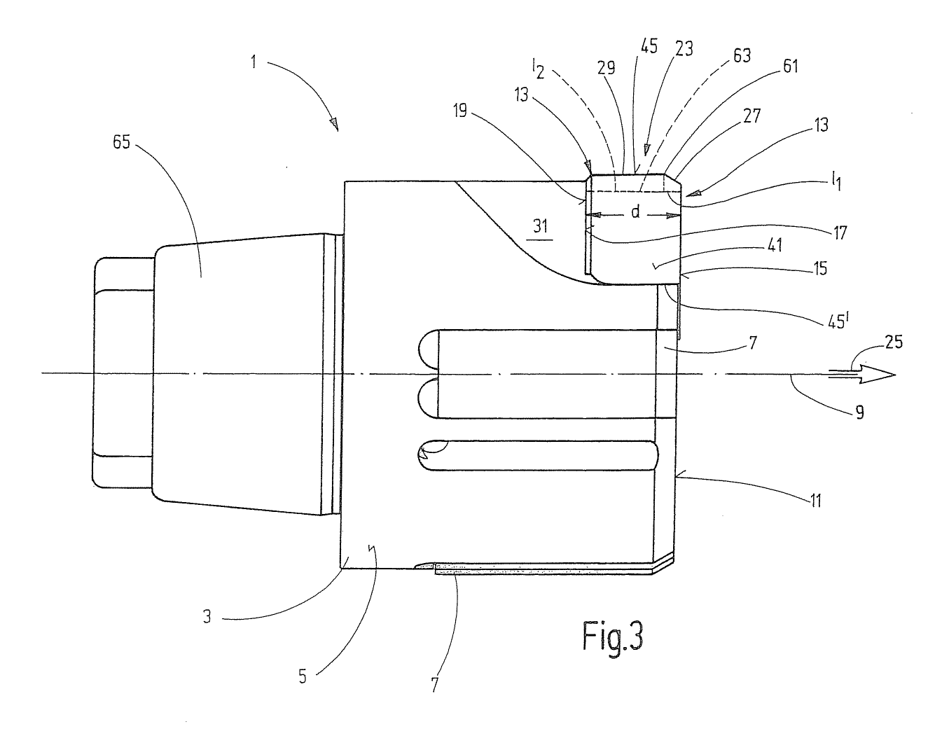

FIG. 3 a side view of the reamer.

The tool shown in FIG. 1, for chip-cutting machining of work pieces, is a reamer 1 having a base body 3, in the circumference surface 5 of which at least one, here three guide strips 7 are inserted, which strips run essentially parallel to the axis of rotation or center axis 9 of the reamer 1. At least one cutting tip is recessed into the face 11 of the reamer 1, essentially tangentially. In the exemplary embodiment of the reamer 1 shown here, a single cutting tip 13 is provided, the front 15 of which faces the observer and the back 17 of which lies against the base body 3 of the reamer 1, on a support surface 19 that is practically completely covered. The reamer 1 serves to remove chips from a bore. For this purpose, the tool is generally put into rotation and introduced into a bore of a work piece that is standing still. Fundamentally, it is possible to hold the reamer 1 in place and to put the work piece into rotation. If, as is usual, the reamer 1 is put into rotation in the direction of the arrow 21, then chips are removed from a bore surface by a cutting region 23 of the cutting tip 9, which region projects beyond the circumference surface 5 in the radial direction, in other words perpendicular to the center axis 9. While working the work piece, the reamer 1 is advanced in the direction of the double arrow 25, in other words in the direction of its center axis 9.

From FIG. 1, it is evident that a section of the cutting region 23 is inclined in the advancing direction. This is the major cutting edge 27 of the cutting tip 13. A section that comprises only one region inclined in the advancing direction is shown here as an example. However, it is possible to provide a first region of the major cutting edge here, which is adjacent to the face 11, which drops by 45° in the advancing direction, for example, and another region that lies behind it, viewed in the advancing direction, which is inclined by 3° to 5° in the advancing direction. Such a configuration is also called a double cut.

The major cutting edge 27, if applicable the less inclined region of the major cutting edge, is followed by another section of the cutting region 23, the minor cutting edge 29. This is inclined counter to the advancing direction indicated by the double arrow 25, and drops, viewed from the major cutting edge 27, by 1 μ/mm to 3 μ/mm, preferably by 1 μ/mm in the direction toward the center axis 9. Such a configuration of a minor cutting edge is known. It is also referred to as a narrowing.

In the working of a work piece, chips are therefore first removed from the wall of a bore to be worked by the major cutting edge 27. The region worked, in this connection, is subsequently worked by the minor cutting edge 29. The narrowing serves to prevent jamming of the reamer in the worked bore, and to guarantee optimal surface quality. The minor cutting edge 29, which is inclined relative to the center axis 9, is not necessarily in engagement with the bore surface over its entire length, which is measured from the major cutting edge 27 all the way to the back 17 of the cutting tip 13. Preferably, it is provided that proceeding from the bending point between major cutting edge and minor cutting edge, a region of 3 mm of the minor cutting edge 29 is active, in other words enters into engagement with the bore wall of a work piece.

The chips removed by the cutting region 23 get into a recess in the base body 3 of the reamer 1, which is referred to as a chip chamber 31, and can be transported away, so that the worked bore surface is not damaged by chips. For cooling and for transport removal of the chips, as well as for lubrication of the cutting region 23, a coolant/lubricant can be made available by way of a channel 33 that opens into the chip chamber.

A recess 35 is introduced into the cutting tip 13, the longitudinal axis of which recess stands perpendicular on the front 15 and on the back 17, and furthermore on the support surface 19. A tightening screw 39 passes through the recess 35, with which screw the cutting tip 13 is attached to the base body 3 of the reamer 1 and pressed against the support surface 19 with its back 17. The head of the tightening screw 39 lies recessed in the recess 35 in the cutting tip 13.

It is provided that the support surface 19 drops in the radial direction, in other words viewed from the center axis 9, in the direction toward the circumference surface 5 of the reamer 1, namely by 1 μ/mm to 3 μ/mm, preferably by 1 μ/mm. Since the minor cutting edge 29 runs perpendicular relative to the back 17 of the cutting tip 13, this incline of the support surface 19 serves to set the narrowing of the minor cutting edge 29, in other words its incline relative to the center axis 9. Preferably, in this connection, the longitudinal axis 27 of the tightening screw 39, relative to the center axis, is also inclined in such a manner that, as stated above, it stands perpendicular on the support surface 19.

From the representation according to FIG. 1, it can be seen that the cutting tip 13—seen in a top view—is configured as a parallelogram. A first side surface 41 has a direction of rotation indicated by the arrow 21. The opposite side 41′ lies against a delimitation wall of a recess 43 introduced into the base body 3 of the reamer 1, which recess accommodates the cutting tip 13. An outer longitudinal side 45 of the reamer points outward. An opposite inner longitudinal side 45′ lies against an inner wall 47 of the recess 43. An adjustment device, not shown here, acts on this inner longitudinal side 45′, and serves to adjust the projection of the cutting region 23 beyond the circumference surface 5 of the reamer 1, and thus the diameter of the tool.

The cutting tip 23 preferably has two cutting regions. Diametrically opposite the cutting region 23, a cutting region 23′ is provided. In the event of wear of the cutting region 23, the tightening screw 39 can be loosened. The cutting tip 13 is then rotated by 180°, about the longitudinal axis 37, set back into the recess 43, and then braced in place using the tightening screw 39.

FIG. 2 shows the reamer according to FIG. 1 in a face view, in other words, the face 11 of the reamer 1 lies in the figure plane of FIG. 2. Parts that are the same are provided with the same reference numbers, so that in this regard, reference is made to the preceding description.

The cutting tip 13 is recessed into the base body 3 of the reamer 1, specifically into the recess 45. In this connection, it lies on the support surface 19 provided on the base body 3 of the reamer 1, which surface is almost completely covered with the back of the body, covered up here, that lies opposite its front 15. The cutting tip 13 is penetrated by a tightening screw 39, which is accommodated in a recess 35 in the cutting tip 13, and screwed into the base body 3, in order to attach the cutting tip 13 to the base body 3 of the reamer.

The top view of the reamer 1 and of the cutting tip 13 shows that this is configured as a polygon and essentially has the shape of a parallelogram. Preferably, it is implemented as a rhombus, where a first side 41 faces in the direction of rotation of the reamer 1 indicated by the arrow 21. The opposite side 41′ lies against a delimitation wall 49 of the recess 43, so that the cutting tip 13 is securely supported. The outer longitudinal side 45 that lies in the region of the circumference surface 5 of the reamer 1 forms the cutting region 23 of the cutting tip 13, in the intersection region with the first side 41. The longitudinal side 45′ that lies opposite the longitudinal side 45 lies against the inner wall 47 of the recess 43, which wall runs at an acute angle relative to the delimitation wall 49. Because of this acute angle of the walls of the recess 43, the cutting tip 13 is held in the base body 3 of the reamer 1 with a precise orientation.

Diagonally opposite the cutting region 23 lies the cutting region 23′, which can come into engagement with a work piece to be worked in the event of wear of the active cutting region 23 shown in FIG. 2, by means of rotating the cutting tip 13 about the center axis of the tightening screw 39.

Immediately adjacent to the cutting region 23, a free surface 51 can be seen, which is part of the longitudinal side 45.

From the face view according to FIG. 2, it is evident that viewed in the direction of rotation indicated by the arrow 21, a first guide strip trails the cutting region 23 by about 75°, while a second guide strip is disposed diametrically opposite the cutting region 23. The third guide strip is situated offset by 90°, and is offset, relative to the cutting region 23, by 270° counter to the direction of rotation, in other words trails the cutting region 23, as in the case of the other guide strips. Here, the angle information relates to an imaginary line 52 that is drawn in here, as an example, only for one of the three guide strips.

In FIG. 2, an in-circle 53 is drawn in with a dotted line, with a diameter 55. This diameter is selected in such a manner that the in-circle 53, which is drawn about the center point 57 of the recess 35, is tangential to the sides 41, 41′, 45, 45′ of the cutting tip 13.

FIG. 3 shows the reamer 1 in a side view, which is disposed in such a manner here that the first side 41 of the cutting tip 13 is shown in a front view. It therefore lies parallel to the figure plane of FIG. 3. Parts that are the same are provided with the same reference numbers, so that in this regard, reference is made to the preceding description, in order to avoid repetition.

It is clearly evident that the cutting tip 13 is inserted quasi tangentially into the face 11 of the reamer 1. The aforementioned back 17 runs parallel to its front 15, and lies on the support surface 19 in the base body 3 of the reamer 1.

The cutting region 23 of the cutting tip 13 has a major cutting edge 27 inclined in the advancing direction indicated by the double arrow 25, which makes a transition, by way of a bending point 61, into the minor cutting edge 29 inclined in the opposite direction. This cutting edge, as stated above, is inclined by 1 μ/mm to 3 μ/mm, preferably by 1 μ/mm, and thus drops off, proceeding from the bending point 61, in the direction toward the center axis 9. In order to achieve this, the support surface 19 is inclined accordingly, relative to the face 11 of the reamer 1, so that the minor cutting edge 23 can run at a right angle relative to the back 17 of the cutting tip 13.

In FIG. 3, the thickness d of the cutting tip 13 is drawn in, measured along an imaginary line that runs perpendicular on the front 15 as well as on the back 17 of the cutting tip 13.

If one projects the length of the major cutting edge 27 onto an imaginary line 63, and also the length of the minor cutting edge 29, then, measured from the front 15 of the cutting tip 13, a length I₁ of the major cutting edge 27 of 1.3 mm and a length I₂ of the minor cutting edge 29 of 3 mm are obtained.

It has been shown that the length I₁ can vary in a range of approximately 0.5 to 1.8 mm, but that a length of 1.3 mm is optimal.

The same holds true for the length I₂ of the minor cutting edge 29. This can vary in a range of 2 to 5 mm, but a length I₂=3 mm has particularly proven itself.

From FIG. 3, it is evident that the thickness d results from the addition of the lengths of the major cutting edge and the minor cutting edge 27, 29. Therefore it holds true that I₁+I₂=d.

In order to achieve an optimal working quality of a bore surface that is worked with the cutting region 23 of the reamer 1, the cutting tip 13 must lie securely against the support surface 19 on the base body 13 of the reamer 1. This is achieved by means of the tightening screw 39 mentioned above. By means of an adjustment device, not shown here, the projection of the cutting region 23 beyond the circumference surface 5 of the reamer 1 can be adjusted. In this connection, the back 17 of the cutting tip 13 slides along on the support surface 19. In order to guarantee precise narrowing even in the event of an adjustment of the cutting tip 13, in other words a drop of the minor cutting edge 29 proceeding from the bending point 61 toward the center axis 9, secure contact of the cutting tip 13 on this support surface 19 is required.

It has been shown that at a certain ratio of the diameter 55 of the in-circle relative to the thickness d of the cutting tip 13, optimal seating of the cutting tip 13 in the base body 3 of the reamer 1 is obtained.

A ratio of the diameter 55 to the thickness d of at least approximately 1.2 to maximally 1.5 has particularly proven itself.

The tip thickness d of the cutting tip 13, as stated above, is determined by the length I₁ of the major cutting edge 27 and the length I₂ of the minor cutting edge 29. Thus, a thickness d of at least 4.3 mm is obtained.

The reamer 1 can be fastened to a machine tool, an adapter and/or an intermediate piece in any desired manner, specifically preferably by means of a conical shaft 65. This does not need to be discussed in greater detail here, because fastening of a reamer 1 to a machine tool or the like is known. In this connection, very precise coupling of the reamer 1 with a machine tool is required, because the cutting tip 13 described here serves for precision machining of bore surfaces, where the narrowing discussed here is of particular importance.

The design of the cutting tip 13 described here leads to very good machining conditions, particularly if the ratio of the diameter 55 of the in-circle relative to the thickness d of the cutting tip 13 amounts to at least 1.2. In this connection, a length I₁ of the major cutting edge 27 von 1.3 mm has particularly proven itself, also if this has a double cut, in other words two regions, proceeding from the bending point 61, which are inclined at different angles in the advancing direction indicated by the arrow 25. In this connection, a length I₂ of the minor cutting edge 27 of 3 mm is selected, so that a tip thickness d of 4.3 mm is obtained.

1-6. (canceled)

7. A reamer comprising:
a base body;
at least one cutting tip disposed essentially parallel to a face of the reamer, the at least one cutting tip having a geometrically defined major cutting edge and a geometrically defined minor cutting edge and being held by a tightening screw that penetrates the cutting tip at a support surface of the base body of the reamer, a back of the cutting tip is polygonal in a bottom view and lies against the support surface; and
an adjustment device having an adjustment screw that acts on the cutting tip, the adjustment screw introduces adjustment forces into a side surface of the cutting tip, in an engagement region;
wherein a ratio of a diameter of an imaginary in-circle, which is tangential to side edges of the back of the cutting tip, lies in a range of approximately 1.0 to 1.5 relative to the thickness of the cutting tip.

8. The reamer according to claim 7, wherein the ratio of the diameter of the imaginary in-circle lies in a range of 1.2 to 1.5 relative to the thickness of the cutting tip.

9. The reamer according to claim 7, wherein the cutting tip is configured to be polygonal.

10. The reamer according to claim 7, wherein the cutting tip is configured to be quadragonal.

11. The reamer according to claim 7, wherein the cutting tip, as seen in a top view, is configured as a parallelogram.

12. The reamer according to claim 7, wherein the cutting tip, as seen in a top view, is configured as a rhombus.

13. The reamer according to claim 7, wherein a length of the minor cutting edge is approximately 2 mm to 5 mm.

14. The reamer according to claim 7, wherein a length of the minor cutting edge is approximately 3 mm.

15. The reamer according to claim 7, wherein the major cutting edge of the cutting tip has a length of approximately 0.5 mm to 1.8 mm.

16. The reamer according to claim 7, wherein the major cutting edge of the cutting tip has a length of approximately 1.3 mm.

17. The reamer according to claim 7, wherein the major cutting edge has two cutting regions to implement a double cut.
